(19) United States
(12) Patent Application Publication
(10) Pub. No.: US 2024/0327265 A1
(43) Pub. Date: Oct. 3, 2024

(54) LARGE-SCALE IN-SITU DEWATERING TREATMENT METHOD AND DEVICE FOR LAKE SLUDGE

(71) Applicant: Nanjing Hydraulic Research Institute, Nanjing (CN)

(72) Inventors: Ziwu Fan, Nanjing (CN); Rui Ding, Nanjing (CN); Chen Xie, Nanjing (CN); Dandan Li, Nanjing (CN); Hao Liu, Nanjing (CN); Yu Chen, Nanjing (CN); Ji Wu, Nanjing (CN); Xiaoyu Wang, Nanjing (CN); Kai Yu, Nanjing (CN); Qiupeng Cai, Nanjing (CN)

(21) Appl. No.: 18/619,580

(22) Filed: Mar. 28, 2024

(30) Foreign Application Priority Data
Mar. 30, 2023 (CN) 2023103274873

(51) Int. Cl. C02F 11/14; C02F 1/48; C02F 1/52; C02F 11/121; C02F 103/00

(52) U.S. Cl. CPC C02F 11/14; C02F 11/121; C02F 1/48; C02F 1/52; C02F 2103/007

(57) ABSTRACT

A large-scale in-situ dewatering treatment method and device for lake sludge are provided. The large-scale in-situ dewatering treatment method for lake sludge includes: step S1, sludge excavation: excavating sludge from a lake and transporting the sludge to a detention pond; step S2, in-situ detention: filtering the sludge in the detention pond to obtain filtered sludge; step S3, dewatering: transporting the filtered sludge to a dewatering workshop and performing deep dewatering on the filtered sludge to obtain mud blocks and wastewater; and step S4, environmental protection treatment: using the mud blocks to build an island near a dredging platform in the lake. The large-scale in-situ dewatering treatment method for lake sludge not only solves the problems of difficulty in selecting a temporary sludge disposal site and high capital investment costs in a traditional lake dredging operation, but also reduces the transportation cost of transporting sludge to a land.

### TECHNICAL FIELD

The present disclosure relates to the technical field of water conservancy and dredging of lake, in particular to a large-scale in-situ dewatering treatment method and device for lake sludge.

### BACKGROUND

Lake sludge treatment is a process in which sludge is treated, solidified, dewatered, stabilized, dried, or incinerated.

At present, main dredging methods for different types of lakes in China include dry river dredging and wet river dredging, but regardless of whether it is the dry or wet river dredging, the sludge produced in the dredging process needs to be transported to a land-based sludge disposal site for dewatering and drying. Lake dredging generally has a large volume and a large amount of sludge, so it is often difficult to select a suitable temporary sludge disposal site nearby. The selection of the location of the sludge disposal site directly affects overall capital investment of a dredging project, that is, the farther the sludge disposal site is arranged, the longer a sludge transportation pipeline needs to be laid. Concurrently, as the sludge transportation pipeline lengthens, the pressure required for transportation increases, which in turn necessitates more pipeline pressurization devices. As a result, it is difficult to select a temporary land-based sludge disposal site and the overall capital investment is large.

Therefore, the present disclosure provides a large-scale in-situ dewatering treatment method and device for lake sludge, which not only solves the problems of difficulty in selecting a temporary sludge disposal site and high capital investment costs in a traditional lake dredging operation, but also reduces the transportation cost of moving sludge to a land.

### SUMMARY

The presents disclosure provides a large-scale in-situ dewatering treatment method and device for lake sludge to solve the above problems. The present disclosure not only solves the problems of difficulty in selecting a temporary sludge disposal site and high capital investment costs in a traditional lake dredging operation, but also reduces the transportation cost of moving sludge to a land.

A technical solution of the present disclosure are as follows.

A large-scale in-situ dewatering treatment method for lake sludge, includes:
step S1, sludge excavation: excavating sludge from a lake and transporting the sludge to a detention pond;
step S2, in-situ detention: filtering the sludge in the detention pond to obtain filtered sludge;
step S3, dewatering: transporting the filtered sludge to a dewatering workshop and performing deep dewatering on the filtered sludge in the dewatering workshop to obtain mud blocks and wastewater; and transporting the wastewater to a wastewater treatment device for treatment; and
step S4, environmental protection treatment: using the mud blocks to build an island near a dredging platform in the lake.

The present disclosure has the beneficial effects: the sludge in the lake is excavated and transported to the detention pond, then the sludge is filtered and dewatered to form mud blocks, and the mud blocks are used to build an island near the dredging platform in the lake. The present disclosure not only solves the problems of difficulty in selecting a temporary land-based sludge disposal site and high capital investment costs in a traditional lake dredging operation, but also reduces the transportation cost of moving sludge to a land.

On the basis of the above technical solution, the present disclosure can also make the following improvements.

In an embodiment, in the step S1, the sludge is transported to the detention pond after being sucked by a pipeline or a dredging ship.

The beneficial effect of the above scheme is as follow: the sludge is directly transported to the detention pond through outer pipelines after being sucked by the pipeline or the dredging ship, which reduces equipment investment and transportation costs.

In an embodiment, in the step S2, after filtering the sludge, one or more selected from the group consisting of dewatering agents and solidifying agents are added to the filtered sludge.

The beneficial effect of the above scheme is as follow: the dewatering agent or the solidifying agent is added to the filtered sludge, thereby improving the dewatering efficiency.

In an embodiment, in the step S3, the wastewater is treated with mechanical flocculation sedimentation, ultra-magnetic separation, and coagulation sedimentation in the wastewater treatment device to obtain treated water, and then the treated water is discharged into the lake.

The beneficial effect of the above scheme is as follow: the efficiency of sludge treatment through wastewater treatment is improved.

The present disclosure further provides a large-scale in-situ dewatering treatment device for lake sludge. The large-scale in-situ dewatering treatment device for lake sludge includes a detention pond and a dewatering workshop. The dewatering workshop includes a wastewater treatment device and a sludge dewatering treatment device; an input end of the sludge dewatering treatment device is connected to the detention pond, and an output end of the sludge dewatering treatment device is connected to the wastewater treatment device.

The beneficial effect of the above scheme is as follow: the sludge in the detention pond is transported to the sludge dewatering treatment device for further dewatering treatment, thereby improving the efficiency of sludge treatment.

In an embodiment, the large-scale in-situ dewatering treatment device for lake sludge further includes a sludge transporting pipe. The dewatering workshop further includes intermediate pipes; the sludge dewatering treatment device is present in plurality, and the plurality of sludge dewatering treatment devices are connected to each other through the intermediate pipes; and the plurality of sludge dewatering treatment devices are connected to the detention pond through the sludge transporting pipe.

The beneficial effect of the above scheme is as follow: each sludge dewatering treatment device works independently, and sludge dewatering operations are carried out in batches.

In an embodiment, the dewatering workshop further includes a wastewater collection pipe and a dewatering outlet pipe; the sludge dewatering treatment device is connected to the wastewater treatment device through the wastewater collection pipe; and the dewatering outlet pipe is disposed on the wastewater treatment device.

The beneficial effect of the above scheme is as follow: the sludge dewatering treatment device transports the wastewater through the wastewater collection pipe to the wastewater treatment device for further treatment. After the wastewater treatment is completed, the treated water will be discharged into the lake through the dewatering outlet pipe.

In an embodiment, the dewatering workshop further includes a workshop sludge inlet located in a center of the sludge dewatering treatment device.

The beneficial effect of the above scheme is as follow: the workshop sludge inlet is used to make the sludge automatically flow into the sludge dewatering treatment device for further treatment.

In an embodiment, the large-scale in-situ dewatering treatment device for lake sludge further includes support piles. The dewatering workshop is installed on the lake through the support piles.

### BRIEF DESCRIPTION OF DRAWINGS

FIG. 1 illustrates a flowchart of a large-scale in-situ dewatering treatment method for lake sludge in an embodiment of the present disclosure.

FIG. 2 illustrates a structural schematic diagram of a large-scale in-situ dewatering treatment device for lake sludge in an embodiment of the disclosure.

### DESCRIPTION OF REFERENCE NUMERALS

1—detention pond; 2—sludge transporting pipe; 3—support pile; 4—dewatering workshop; 5—dewatering outlet pipe; 6—workshop sludge inlet; 7—sludge dewatering treatment device; 8—wastewater collection pipe; 9—wastewater treatment device; 10—intermediate pipe.

### DETAILED DESCRIPTION OF EMBODIMENTS

The principles and features of the present disclosure will now be described with reference to attached drawings, embodiments are given only for explaining the present disclosure and are not intended to limit a scope of the present disclosure.

In the description of the present disclosure, it is to be understood that terms including “center”, “length”, “upper”, “lower”, “front”, “back”, “left”, “right”, “vertical”, “horizontal”, “top”, “inner”, “outer”, “peripheral, “circumferential”, and the like indicate an orientation or positional relationship based on the orientation or positional relationship shown in the drawings. The terms are intended only to facilitate description of the present disclosure and to simplify the description, and are not intended to indicate or imply that the systems or components referred to must have a particular orientation, be constructed in a particular orientation, and operate in a particular manner, and therefore should not be construed as limiting the present disclosure.

In the description of the present disclosure, “multiple” means at least two, such as two, three, etc., unless otherwise specified.

In the present disclosure, the terms including “install”, “connect”, “communicate”, and “fix” are to be interpreted in a broad sense, for example, they may be a fixed connection, a detachable connection or an integral connection; they may be a mechanical connection or an electrical connection; they may be a direct connection or an indirect connection through an intermediate medium, and they may be an internal communication of two elements or an interaction relationship of two elements, unless otherwise specified. Those of ordinary skill in the art can understand specific meanings of the above terms in the present disclosure according to specific situations.

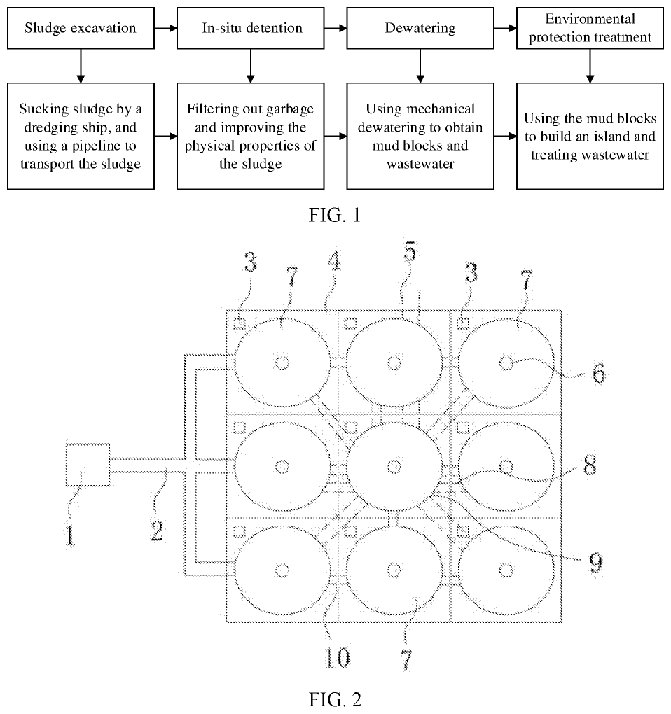

Referring to FIG. 1 and FIG. 2, a large-scale in-situ dewatering treatment method for lake sludge includes the following steps.

Step S1, sludge excavation: sludge is excavated from a lake and the sludge is transported to a detention pond 1. Specifically, the sludge is excavated by pipeline suction or dredging ship suction, and then the sludge is transported to the detention pond 1 by a sludge pump. In another embodiment, for shallow lakes, the sludge can also be directly excavated into the detention pond 1 by an excavator.

Step S2, in-situ detention: the sludge in the detention pond 1 is filtered to obtain filtered sludge. Specifically, a filtration device is installed in the detention pond 1 to filter out large particle stones, grass roots, bark, etc. After filtering the sludge, one or more dewatering agents and solidifying agents are added to the filtered sludge to adjust its physical properties, which is beneficial for improving the subsequent dewatering and solidifying performance.

Step S3, dewatering: the filtered sludge is transported to a dewatering workshop 4. Deep dewatering is performed on the filtered sludge in the dewatering workshop 4 to obtain mud blocks and wastewater, and the wastewater is transported to a wastewater treatment device 9 for treatment. Specifically, the sludge is transported to the dewatering workshop 4 for deep dewatering, which greatly reduces a water content of the sludge and can obtain mud blocks with small volumes.

The wastewater is treated with mechanical flocculation sedimentation, ultra-magnetic separation, and high-efficiency coagulation sedimentation in the wastewater treatment device 9 to obtain treated water with qualified discharging indicators, and then the treated water is discharged into the lake.

Step S4, environmental protection treatment: the mud blocks are used to build an island near a dredging platform in the lake. Specifically, by utilizing the technology of island construction in the center of the lake, the mud blocks can be used in-situ for island building, thereby reducing the accumulation of the sludge.

In the present disclosure, the sludge in the lake is excavated and transported to the detention pond 1, then the sludge is filtered and dewatered to form mud blocks, and the mud blocks are used to build the island near the dredging platform in the lake. The present disclosure not only solves the problems of difficulty in selecting a temporary land-based sludge disposal site and high capital investment costs in a traditional lake dredging operation, but also reduces the transportation cost of moving sludge to a land.

Referring to FIG. 2, a large-scale in-situ dewatering treatment device for lake sludge includes a detention pond 1 and a dewatering workshop 4. The dewatering workshop 4 includes a wastewater treatment device 9 and a sludge dewatering treatment device 7. An input end of the sludge dewatering treatment device 7 is connected to the detention pond 1, and an output end of the sludge dewatering treatment device 7 is connected to the wastewater treatment device 9.

In some embodiments, the dewatering workshop 4 includes multiple sludge dewatering treatment devices 7 and intermediate pipes 10. The multiple sludge dewatering treatment devices 7 are connected to each other through the intermediate pipes 10. The dewatering workshop 4 further includes workshop sludge inlets 6 respectively located in centers of the sludge dewatering treatment devices 7. Each sludge dewatering treatment device 7 works independently, and the sludge dewatering operations are carried out in batches. The dewatering workshop 4 is installed on the lake through support piles 3. The dewatering workshop 4 does not require to select a specific location, thereby improving the space utilization rate of the present disclosure. The dewatering workshop 4 adopts a dredging platform supported by steel pipe piles, and each operation room on the platform is assembled. The dredging platform is disposed above the historical highest water level of the lake, and an overall construction size of the dredging is determined by a size of the lake, an overall dredging amount of the lake, and the number of dredging work rooms required.

Specifically, the multiple sludge dewatering treatment devices 7 are connected to the detention pond 1 through the sludge transporting pipe 2. The sludge transporting pipe 2 is configured to transport the filtered sludge in the detention pond 1 to the multiple sludge dewatering treatment devices 7. Each of the multiple sludge dewatering treatment devices 7 is connected to the wastewater treatment device 9 through a wastewater collection pipe 8. The dewatering workshop 4 further includes a dewatering outlet pipe 5. The dewatering outlet pipe 5 is disposed on the wastewater treatment device 9. The dewatering outlet pipe 5 is configured to discharge the treated water into the lake.

### Embodiment 1

(1) Survey and investigation: a thickness, an area and a pollution degree of sludge in a lake are measured, and survey points are arranged in a grid shape at an interval of 50 meters to 100 meters to determine a spatial distribution of the sludge, so as to determine overall dredging quantities and calculate a construction scale of a dredging platform. By consulting historical hydrological data of the lake to determine the minimum height of the dredging platform.

(2) Construction of the dredging platform: the whole dredging platform is constructed with steel structures. The foundation construction of the dredging platform uses supporting piles 3 as the support. The supporting piles 3 mostly use steel pipe piles. The construction density of the steel pipe piles is determined through load calculation. Then longitudinal beams and longitudinal diagonal bracing are installed, channel steel is laid and fixed to the longitudinal beams, and steel track slabs are laid to form a steel operation platform. At least one detention pond 1 and multiple sludge dewatering treatment devices 7 are arranged on the steel operation platform, a wastewater treatment device 9 is arranged in a center of the steel operation platform, all the operation rooms use assembled box bodies, the number of the assembled box bodies can be increased or decreased according to the actual requirements on the site, the operations rooms are arranged in a grid shape or a ring shape, and the sludge is transported through connections of pipelines.

(3) Sludge excavation: wet dredging is adopted, and the lake sludge is sucked by a dredging ship. Then the sludge is transported to the dredging operation platform through pipelines or barges.

(4) In-situ detention: a filter is provided to filter out large particle stones, grass roots, bark, etc. After filtration, appropriate dewatering agents and solidifying agents are added to the filtered sludge to adjust its physical properties, thereby improving dewatering and solidification performance of the filtered sludge.

(5) Dewatering: the sludge in the detention pond 1 is transported to different sludge dewatering treatment devices 7 in batches. Screw stacking devices are arranged in the sludge dewatering treatment devices 7 to perform deep dewatering on the filtered sludge, then the filtered sludge is formed into mud blocks after the filtered sludge is dewatered and dried. Multiple sludge dewatering treatment devices 7 can ensure a continuous operation of the whole dredging project and improve the dredging efficiency.

(6) Environmental protection treatment: the mud blocks formed after sludge dewatering are used to build an island in the lake based on island building technology. The wastewater generated during the sludge dewatering process is purified by the wastewater treatment device 9 to obtain treated water with qualified indicators, and the treated water is directly discharged into the lake.

When the present disclosure is adopted to implement a dredging project, advantages of the present disclosure are as follows: (1) the arrangement of the dredging platform is improved, so that the time for selecting a land temporary sludge disposal site is reduced and the capital investment costs are reduced, and the transportation cost for transporting the sludge to a land is reduced. (2) Different sludge dewatering treatment devices 7 can synchronously work at different times, so that the dredging project has good continuity and large treatment capacity. (3) The mud blocks converted from the sludge in the dredging project can be used in situ. (4) The dredging platform can be used as a semi-permanent facility for subsequent dredging operations.

In the description of the specification, reference to terms such as “an embodiment”, “some embodiments”, “examples”, “specific examples”, or “some examples” mean that the specific features, structures, materials, or characteristics described in conjunction with the embodiments or examples are included in at least one embodiment or example of the present disclosure. In the specification, illustrative expressions of the above terms do not necessarily refer to the same embodiments or examples. Moreover, the specific features, structures, materials, or characteristics described can be combined in an appropriate manner in any one or more embodiments or examples. In addition, those skilled in the art may combine and integrate different embodiments or examples described in this specification, as well as the features of different embodiments or examples, without conflicting with each other.

The above embodiments are only exemplary embodiments of the present disclosure and are not intended to limit the present disclosure. Any modifications, equivalent substitutions, improvements, and others made within the spirit and principles of the present disclosure should be included within the scope of protection of the present disclosure.

What is claimed is:

1. An in-situ dewatering treatment method for lake sludge, comprising:
step S1, sludge excavation: excavating sludge from a lake and transporting the sludge to a detention pond;
step S2, in-situ detention: filtering the sludge in the detention pond to obtain filtered sludge;
step S3, dewatering: transporting the filtered sludge to a dewatering workshop and performing deep dewatering on the filtered sludge in the dewatering workshop to obtain mud blocks and wastewater; and transporting the wastewater to a wastewater treatment device for treatment; and
step S4, environmental protection treatment: using the mud blocks to build an island near a dredging platform in the lake.

2. The in-situ dewatering treatment method for lake sludge as claimed in claim 1, wherein in the step S1, the sludge is transported to the detention pond after being sucked by a pipeline or a dredging ship.

3. The in-situ dewatering treatment method for lake sludge as claimed in claim 1, wherein in the step S2, after filtering the sludge, one or more selected from the group consisting of dewatering agents and solidifying agents are added to the filtered sludge.

4. The in-situ dewatering treatment method for lake sludge as claimed in claim 1, wherein in the step S3, the wastewater is treated with mechanical flocculation sedimentation, ultra-magnetic separation, and coagulation sedimentation in the wastewater treatment device to obtain treated water, and then the treated water is discharged into the lake.

5. An in-situ dewatering treatment device for lake sludge, comprising: a detention pond (1) and a dewatering workshop (4); the dewatering workshop (4) comprises: a wastewater treatment device (9) and a sludge dewatering treatment device (7); an input end of the sludge dewatering treatment device (7) is connected to the detention pond (1), and an output end of the sludge dewatering treatment device (7) is connected to the wastewater treatment device (9).

6. The in-situ dewatering treatment device for lake sludge as claimed in claim 5, further comprising: a sludge transporting pipe (2); wherein the dewatering workshop (4) further comprises: intermediate pipes (10); the sludge dewatering treatment device (7) is present in plurality, and the plurality of sludge dewatering treatment devices (7) are connected to each other through the intermediate pipes (10); and the plurality of sludge dewatering treatment devices (7) are connected to the detention pond (1) through the sludge transporting pipe (2).

7. The in-situ dewatering treatment device for lake sludge as claimed in claim 5, wherein the dewatering workshop (4) further comprises: a wastewater collection pipe (8) and a dewatering outlet pipe (5); the sludge dewatering treatment device (7) is connected to the wastewater treatment device (9) through the wastewater collection pipe (8); and the dewatering outlet pipe (5) is disposed on the wastewater treatment device (9).

8. The in-situ dewatering treatment device for lake sludge as claimed in claim 5, wherein the dewatering workshop (4) further comprises: a workshop sludge inlet (6) located in a center of the sludge dewatering treatment device (7).

9. The in-situ dewatering treatment device for lake sludge as claimed in claim 5, further comprising: support piles (3); wherein the dewatering workshop (4) is installed on the lake through the support piles (3).
